(19) United States
(12) Patent Application Publication
(10) Pub. No.: US 2010/0195020 A1
(43) Pub. Date: Aug. 5, 2010

(54) LIGHT CONTROL SHEET, SURFACE LIGHT SOURCE DEVICE, AND TRANSMISSION-TYPE DISPLAY DEVICE

(75) Inventors: Masahiro Goto, Hiroshima-Ken (JP); Daijiro Kodama, Hiroshima-Ken (JP)

Correspondence Address: BURR & BROWN, PO BOX 7068, SYRACUSE, NY, 13261-7068, US

(73) Assignee: Dai Nippon Printing Co., Ltd., Shinjuku-Ku (JP)

(21) Appl. No.: 12/669,964

(22) PCT Filed: Aug. 14, 2008
(86) PCT No.: PCT/JP2008/064591

§ 371 Date: Jan. 21, 2010

(30) Foreign Application Priority Data
Aug. 14, 2007 (JP) 2007-211353
Aug. 29, 2007 (JP) 2007-222533

(51) Int. Cl. G02F 1/13357; F21V 13/04; F21V 7/00

(52) U.S. Cl. 349/62; 362/327; 362/308

(57) ABSTRACT

A light control sheet, used in a surface light source device having a light source to control a travel direction of light emitted from the light source, including: a base layer; a lens layer having unit lenses arranged on the light outgoing side of the base layer; a light selection layer disposed on the light incident side of the base layer and a light selection layer disposed on the light incident side of the base layer and having light transmission parts transmitting the light therethrough and the light reflection parts reflecting the light; and a support layer disposed on the light incident side of the light selection layer. Each light transmission part is disposed in a region including a position opposite to an apex of each corresponding unit lens in a normal direction to the sheet surface. The light reflection parts are respectively arranged alternately to the transmission parts.

### TECHNICAL FIELD

The present invention relates to a light control sheet for use in a surface light source device for illuminating a liquid crystal display device or the like, and also relates to the surface light source device including the light control sheet, and the transmission-type display device including the light control sheet.

### BACKGROUND ART

In the past, as disclosed in JP2006-208930A, the surface light source device suitable for illuminating a transmission-type display part, such as a liquid crystal display panel or the like, has been known. Generally, the surface light source device is provided with the light control sheet (or optical sheet) including unit optical elements, each having a lens-like shape or prism-like shape. The light control sheet of this type can serve to control a travel direction of light to be within a desired angular range centered on a front direction of the sheet. Specifically, in the above JP2006-208930A, a sheet-like member, which includes a light scattering layer, a light reflection layer having openings formed therein, and a lens layer having a plurality of unit lenses provided thereon, is disclosed as the light control sheet. In this light control sheet disclosed in JP2006-208930A, when seen on the light incident side (input-light side), the light scattering layer, reflection layer and lens layer are arranged in this order.

Usually, the liquid crystal display panel (or LCD panel) is provided with polarizing plates. Therefore, only the light in a certain or particular polarized state can be transmitted through the LCD panel, while the light in the polarized state other than the certain polarized state will be absorbed in the LCD panel. Thus, in order to enhance the brightness, it is highly effective to incorporate a polarizing reflection sheet (reflection-type polarizing sheet) or the like, which can transmit therethrough only the light in the certain polarized state that can be transmitted through the LCD panel, while reflecting the light in the other polarized state, into the surface light source device. With such configuration, the light that cannot be transmitted through the LCD panel, i.e., the light that cannot be directly utilized can be reflected and returned toward a light source. Thereafter, the polarized state of such light returned toward the light source will be changed, by reflection, into a different polarized state. In this way, the light returned to the light source can be eventually brought into a utilizable state, when the light is incident again on the polarizing reflection sheet. This can significantly improve the efficiency of utilizing the light, while effectively enhancing the brightness of the display.

Nevertheless, when the above polarizing reflection sheet is combined with the aforementioned light control sheet disclosed in JP2006-208930A, the front brightness (or brightness in the front direction) cannot be improved so sufficiently. For instance, in the case in which the light control sheet disclosed in JP2006-208930A is used, a relatively large amount of the light outgo in a direction out of the desired angular range centered on the front direction.

### DISCLOSURE OF THE INVENTION

Therefore, it is an object of the present invention to provide an improved light control sheet which can enhance the front brightness with high efficiency. It is another object of this invention to provide the surface light source device and the transmission-type displace device, each includes the improved light control sheet.

A first approach of this invention for achieving the above challenge is based on results that have been obtained through the intensive studies conducted by the inventors of the present invention. For instance, the light control sheet disclosed in the above JP2006-208930A includes the light scattering layer. Therefore, when the polarizing reflection sheet is located on the light source side (or light incident side) of the light control sheet disclosed in JP2006-208930A, the polarized state of the light once transmitted through the polarizing reflection sheet will be considerably disordered. Thus, even through the light in the specified polarized state can be obtained by the polarizing reflection sheet, the brightness cannot be enhanced so sufficiently. Meanwhile, in the case in which the polarizing reflection sheet is located on the observer side (or light outgoing side) of the light control sheet disclosed in JP2006-208930A, a light condensing effect (or collecting effect of the light travel direction) due to the lens layer is rather degraded. Therefore, on the basis of such results that the inventors of the present invention have found, the following first light control sheet, first surface light source device and first transmission-type display device of this invention are provided, respectively.

The first light control sheet of this invention, for use in a surface light source device having a light source, configured to control a travel direction of a light emitted from the light source, the light control sheet comprising: a base layer; a lens layer having unit lenses arranged on the light outgoing side (light outputted side) of the base layer, each unit lens protruding toward the light outgoing side; a light selection layer disposed on the light incident side (light inputted side) of the base layer, and having light transmission parts transmitting the light therethrough and light reflection parts reflecting the light; and a support layer disposed on the light incident side of the light selection layer, wherein the light transmission parts of the light selection layer are disposed in regions, each region including a position opposite to an apex of each corresponding unit lens in a normal direction to a sheet surface, wherein the light reflection parts of the light selection layer are disposed in regions, each region being other than the region in which each light transmission part is disposed, alternatively to the light transmission parts, and wherein the base layer serves as a polarizing optical element configured to transmit therethrough a light in a specified polarized state, from among the light incident on the base layer, while reflecting a light in the polarized state other than the specified polarized state.

In the first light control sheet of this invention, the support layer may have a function of diffusing the light.

In the first light control sheet of this invention, the refractive index of each light transmission part may be lower than the refractive index of the support layer.

In the first light control sheet of this invention, each light transmission part may be a void space formed between two adjacent light reflection parts.

In the first light control sheet of this invention, each unit lens may have a shape corresponding to a part of an elliptic cylinder having an elliptic cross section, or have a shape corresponding to a part of a spheroid having the elliptic cross section, with the major axis of the elliptic cross section extending in the normal direction to the sheet surface.

In the first light control sheet of this invention, the light reflection parts of the light selection layer may be disposed out of regions including light convergence points at which flux of light is converged when the flux of light travelling in a substantially normal direction to the sheet surface is incident on the light control sheet from the side of the lens layer, as well as including regions around the light convergence points.

In the first light control sheet of this invention, the haze value of the support layer may be 30% or less.

In the first light control sheet of this invention, the light reflection parts of the light selection layer may be configured to specularly reflect a light.

In the first light control sheet of this invention, the reflection haze value of each light reflection part may be 20% or less.

In the first light control sheet of this invention, the light selection layer may further include light absorbing parts, and each light absorbing part may be disposed on the light outgoing side of each corresponding light reflection part and having a function of absorbing a light.

The first surface light source device of this invention includes: any suitable one of the first light control sheets of this invention, respectively described above; and the light source configured to emit the light.

The first transmission-type display device of this invention includes: any suitable one of the first surface light source devices of this invention, respectively described above; and a transmission-type display part disposed so as to be illuminated from the back side thereof by the surface light source device.

In the first transmission-type display device of this invention, the transmission-type display part may have the polarizing plate configured to transmit therethrough the light in the specified polarized state, and the polarized state of the light that can be transmitted through the polarizing plate may be the same as the polarized state of the light that can be transmitted through the base layer.

By the way, a second approach of this invention for attaining the above challenge is based on the results that have been obtained through the further intensive studies conducted by the inventors of the present invention. For instance, the light control sheet disclosed in the aforementioned JP2006-208930A further includes the reflection layer provided as an essential component, in addition to the light scattering layer having the function of diffusing the light. However, the reflection layer can also diffuse the light. Thus, the light control sheet may tend to have an excessive light diffusing effect, leading to undue increase of the light that outgoes in the direction out of the desired angular range centered on the front direction. Therefore, on the basis of such results that the inventors of the present invention have obtained, the following second light control sheet, second surface light source device and second transmission-type display device of this invention are provided, respectively.

The second light control sheet of this invention, for use in a surface light source device having a light source, configured to control a travel direction of a light emitted from the light source, the light control sheet comprising: a base layer; a lens layer having unit lenses arranged on the light outgoing side (light outputted side) of the base layer, each unit lens protruding toward the light outgoing side; a light selection layer disposed on the light incident side (light inputted side) of the base layer, and having light transmission parts transmitting the light therethrough and light reflection parts reflecting the light; and a support layer disposed on the light incident side of the light selection layer, wherein the light transmission parts of the light selection layer are disposed in regions, each region including a position opposite to an apex of each corresponding unit lens in a normal direction to a sheet surface, wherein the light reflection parts of the light selection layer are disposed in regions, each region being other than the region in which each light transmission part is disposed, alternatively to the light transmission parts, and wherein a haze value of the support layer is 30% or less.

In the second light control sheet of this invention, the light reflection parts of the light selection layer may be disposed out of regions including light convergence points at which flux of light is converged when the flux of light travelling in a substantially normal direction to the sheet surface is incident on the light control sheet from the side of the lens layer, as well as including regions around the light convergence points.

In the second light control sheet of this invention, the light reflection parts of the light selection layer may be configured to specularly reflect a light.

In the second light control sheet of this invention, the reflection haze value of each light reflection part may be 20% or less.

In the second light control sheet of this invention, the light selection layer may further include light absorbing parts, and each light absorbing part may be disposed on the light outgoing side of each corresponding light reflection part and having a function of absorbing a light.

In the second light control sheet of this invention, each unit lens may have the shape corresponding to the part of the elliptic cylinder having the elliptic cross section, or have the shape corresponding to the part of the spheroid having the elliptic cross section, with the major axis of the elliptic cross section extending in the normal direction to the sheet surface.

In the second light control sheet of this invention, the refractive index of the light transmission parts may be lower than the refractive index of the support layer.

In the second light control sheet of this invention, each light transmission part may be a void space formed between two adjacent light reflection parts.

The second surface light source device of this invention includes: any suitable one of the second light control sheets of this invention, respectively described above; and the light source configured to emit the light.

The second transmission-type display device of this invention includes: any suitable one of the second surface light source devices of this invention, respectively described above; and a transmission-type display part disposed so as to be illuminated from the back side thereof by the surface light source device.

### BRIEF DESCRIPTION OF THE DRAWINGS

FIG. 1 is a diagram for explaining a first embodiment of the present invention. More specifically, FIG. 1 is a perspective view schematically showing the transmission-type display device and surface light source device.

FIG. 2 is a cross section showing the light control sheet incorporated in the transmission-type display device and surface light source device respectively shown in FIG. 1. This cross section is taken along the normal direction relative to the sheet surface of the light control sheet as well as along an arrangement direction of the unit lenses.

FIG. 3 is a diagram for explaining a second embodiment of the present invention. More specifically, FIG. 3 is another perspective view schematically showing the transmission-type display device and surface light source device.

FIG. 4 is a cross section showing the light control sheet incorporated in the transmission-type display device and surface light source device respectively shown in FIG. 3. Again, this cross section is taken along the normal direction relative to the sheet surface of the light control sheet as well as along the arrangement direction of the unit lenses.

FIG. 5 is similar to FIG. 4, and is provided for explaining one variation of the light control sheet.

### MODE FOR CARRYING OUT THE INVENTION

The attached drawings are provided for specifically illustrating each embodiment related to the present invention. In these drawings, each part and/or member is schematically shown, and proper alteration and exaggeration from real things, in scales, numbers and shapes or the like, are utilized for better understanding and clarity of the invention.

It is noted that the terms “plate, sheet and film” are respectively used herein, in accordance with an order of thickness as usually recognized in this field (i.e., the “plate” is generally thicker than the “sheet”, while the “sheet” is usually thicker than the “film”). However, such terms are not intended herein to critically specify or limit the technological meaning, with respect to each plate-like, sheet-like or film-like part or member. Therefore, in the appended claims, the parts or members, respectively expressed by such terms in the following description, will be collectively referred to as the “sheet (or sheets).” Namely, the expressions of such terms “plate, sheet, film and the like” can be altered or exchanged herein with one another. For instance, the light control sheet may be referred to as the light control film or light control plate.

It is noted that numerical values related to the size and the like of each part or member and each name of materials and the like are respectively described, by way of example only, in each embodiment. That is to say, such values and/or names are not respectively limited to those described in each embodiment, but may be optionally selected and/or altered.

Unless otherwise stated, a “vertical direction” and a “horizontal direction” is respectively defined, herein for better understanding, as the “vertical direction” and “horizontal direction” of each of the surface light source device and the transmission-type display device in a used state.

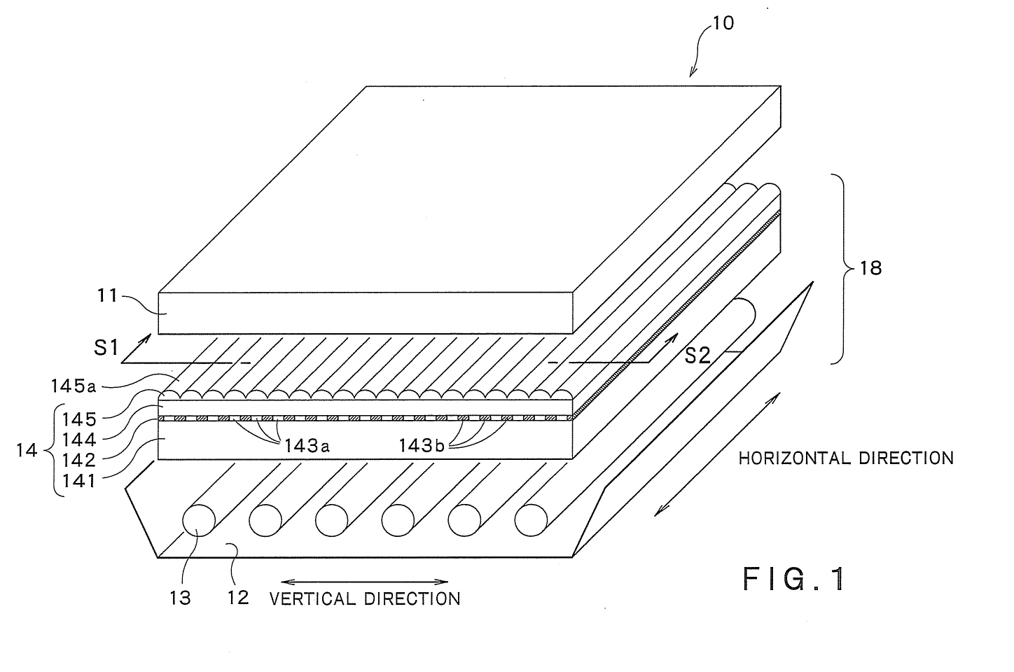

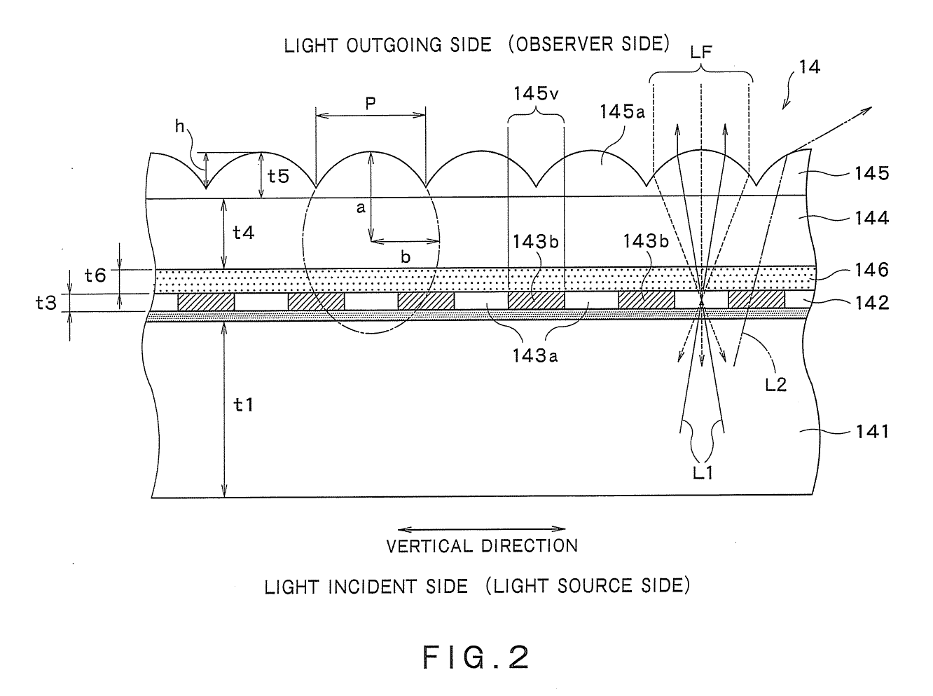

First of all, the first embodiment will be described, with reference to FIGS. 1 and 2 and other related drawings.

### First Embodiment

The transmission-type display device 10 of this embodiment includes the LCD (Liquid Crystal Display) panel 11 used as the transmission-type display part, and the surface light source device 18 adapted for illuminating the LCD panel from the back side of the LCD panel. That is to say, the transmission-type display device 10 is constructed as the liquid crystal display device adapted for illuminating image information created on the LCD panel from the back side of the LCD panel and displaying the image on the panel. The surface light source device 18 includes a reflection plate 12, emission tubes 13 respectively used as the light source, the light control sheet 14 and the like.

The LCD panel 11 is used as the transmission-type display part composed of a transmission type liquid crystal display element. In this embodiment, the LCD panel 11 has a 32-inch (420 mm×740 mm) width across corners and is adapted for providing a 1280×768-dot display. When the LCD panel 11 is in the used state, the horizontal direction of this panel 11 is coincident with a longitudinal direction of each emission tube 13, while the vertical direction of the panel 11 corresponds to the arrangement direction of the respective emission tubes 13 (or direction in which the emission tubes 13 are respectively arranged).

In this embodiment, a liquid crystal material is filled in the LCD panel 11, with the polarizing plates (not shown) respectively attached to both faces, on the light source side (or the light incident side) as well as on the observer side (or the light outgoing side), of the LCD panel 11. Thus, the light in the certain polarized state (e.g., a P-polarized state) can be transmitted through each polarizing plate, while the light in the other polarized state (e.g., an S-polarized state) than the certain polarized state will be absorbed in the polarizing plate. By utilizing this effect of the polarizing plates as well as by controlling the arrangement or orientation of liquid crystal molecules to be changed, for each selected picture-element region, with application of adequate electric voltage, the LCD panel 11 can display any image or images thereon, while allowing only the light in the certain polarized state (e.g., the P-polarized state), among the light coming or inputted from the surface light source device 18, to be transmitted through only the so-selected or certain picture-element regions.

Each emission tube 13 is composed of a linear (more specifically, straight-line) emission element constituting the light source of the surface light source device 18. In this embodiment, a cold-cathode tube is used as each emission tube 13. By way of example, six (6) cold-cathode tubes are shown in FIG. 1. However, in one actual case, eighteen (18) cold-cathode tubes may be arranged, with an approximately 20 mm interval provided therebetween. On the back side of the emission tubes 13, the reflection plate 12 is provided. This reflection plate 12 extends over all of the emission tubes 13, on the side opposite to the light control sheet 14 (or on the back side of the tubes 13). The reflection plate 12 can serve to diffuse and reflect the light traveling from each emission tube 13 toward the back side (or side opposite to the observer side) and then return such diffused and reflected light toward the observer side (or light outgoing side). In this way, the efficiency of utilizing the light emitted from each emission tube 13 can be successfully enhanced. Additionally, with the light diffusing effect of the reflection plate 12, variation of the amount of the light inputted to each point of the light control sheet 14 can be well reduced.

The cross section of FIG. 2 showing the light control sheet 14 is taken along line S1-S2 depicted in FIG. 1. More specifically, the cross section of FIG. 2 is taken along the normal direction to the surface (or sheet surface) of the light control sheet 14 as well as along the arrangement direction of the unit lenses 145a that will be described later. As used herein, the “sheet surface” refers to the surface extending along a plane direction of each sheet-like part or member (i.e., each plate, sheet, film or layer) of interest, when such a sheet-like part or member is totally seen. For instance, in this embodiment, the sheet surface of the light control sheet 14 extends in parallel with the surface on the light incident side (input light side) of the light control sheet 14 (or surface of the sheet 14 on the side of the emission tubes 13), and also extends in parallel with the sheet surface (or layer surface) of each layer included in the light control sheet 14. Further, the sheet surface of the light control sheet 14 also extends in parallel with a light emitting surface (or surface on the light outgoing side (light output side)) of the surface light source device.

The light control sheet 14 includes the support layer 141, the light selection layer 142 (including the light transmission parts 143a and light reflection parts 143b), the base layer 144 and the lens layer 145, respectively arranged in this order when the light control sheet 14 is seen from the side of the emission tubes 13. This light control sheet 14 is configured to have such an optical function of changing the travel direction of the light which is transmitted through the sheet 14. More specifically, the light control sheet 14 has a function (that will be merely referred to as a “light diffusing effect”) of changing the light travel direction in order to diffuse the transmitted light, as well as a function (that will be merely referred to as a “light condensing effect or light collecting effect”) of changing the light travel direction in order to lessen the angle defined between the travel direction of the transmitted light and the front direction (or normal direction relative to the sheet surface). Due to the light diffusing effect, unevenness of the brightness attributable to given arrangement of light-source components (i.e., the emission tubes 13) can be well controlled, thus rendering the light image of each emission tube significantly inconspicuous. Meanwhile, due to the light condensing effect (the light collecting effect), the front brightness can be considerably improved.

The support layer 141 is located nearest to the emission tubes 13 (or on the most light incident side) in the light control sheet 14, and serves as a layer for supporting the other layers including the lens layer 145 and the like, respectively provided on the side of the LCD panel 11 (or light outgoing side) relative to the support layer 141. Thus, it is preferred that the support layer 141 has a greater thickness and is more rigid, as compared with the other layers constituting the light control sheet 14. Further, the support layer 141 contains a light diffusing material that can be used for scattering the light transmitted through this layer 141. Accordingly, this support layer 141 also has a non-directional light diffusing function of diffusing a light non-directionally. In this embodiment, the support layer 141 is a sheet-like member formed from a polystyrene (PS) resin and having a 1.5 mm thickness (t1). Further, this support layer 141 contains micro-beads formed from an acryl resin.

Between the support layer 141 and the light selection layer 142, a joining layer 147 for joining these layers 141 and 142 to each other is provided. This joining layer 147 is provided as a transparent layer having a function for joining the support layer 141 and light reflection parts 143b together. In this embodiment, a pressure sensitive adhesive having a 5 μm thickness is used as the joining layer 147. However, the joining layer 147 is not limited to this example, but may be formed from any other suitable material than the pressure sensitive adhesive. For instance, as the joining layer 147, a photosensitive adhesive, or a sheet-like, film-like or tape-like member exhibiting proper adhesive properties on both faces thereof may be optionally used.

The light selection layer 142 provided between the support layer 141 and the base layer 144 includes the plurality of light transmission parts 143a and light reflection parts 143b. The light transmission parts 143a and light reflection parts 143b are alternately arranged in the vertical direction (i.e., in the arrangement direction of the unit lenses 145a that will be described later).

Each light transmission part 143a is provided for transmitting the light therethrough, and is located corresponding to each unit lens 145a. More specifically, each transmission part 143a is provided in a region including a position directly opposite to an apex portion of each corresponding unit lens 145a (or opposite to each portion of the unit lens 145a that is farthest from the base layer 144), in the normal direction relative to the sheet surface of the light control sheet 14. Further, each light transmission part 143a is positioned in the region such that parallel flux of the light LF coming in the normal direction relative to the sheet surface of the light control sheet 14 and inputted into the light control sheet 14 on the side of the lens layer 145, as shown in FIG. 2, can be transmitted through the light control sheet 14. Furthermore, each light transmission part 143a is provided so as to occupy the region including the light convergence point at which the flux of light LF can be converged and the additional region around the light convergence point, in the cross section taken along the normal direction relative to the sheet surface of the light control sheet 14 as well as along the arrangement direction of the unit lenses 145a that will be described later.

It is preferred that each light transmission part 143a is formed from a material having a refractive index lower than each of the refractive indexes of the support layer 141, base layer 144 and lens layer 145. In this embodiment, each light transmission part 143a is provided as a void space located between each adjacent pair of the light reflection parts 143b, and a suitable gas, usually air, is filled in this void space. In the case in which each light transmission part 143a is formed of the air filled in the void space located between the two adjacent light reflection parts 143b, the refractive index of the light transmission part 143a is 1.

Each light reflection part 143b can serve to reflect the light, and is provided in the region other than the region in which each light transmission part 143a is provided in the light selection layer 142. In this case, the light reflection parts 143b are respectively arranged alternately to the light transmission parts 143a, in the arrangement direction of the unit lenses 145a that will be described later. More specifically, each light reflection part 143b is provided in the region including a position directly opposite to a valley portion 145v between each two adjacent unit lens 145a, in the normal direction relative to the sheet surface of the light control sheet 14. Further, in this embodiment, each light reflection part 143b is positioned in the region which the flux of light LF coming in the normal direction relative to the sheet surface of the light control sheet 14 and inputted toward the light control sheet 14 on the side of the lens layer 145, as shown in FIG. 2, does not pass through (is not incident on). That is to say, each light reflection part 143b is provided out of the region including the light convergence point at which the flux of light LF can be converged and the additional region around the light convergence point, in the cross section taken along the normal direction relative to the sheet surface of the light control sheet 14 as well as along the arrangement direction of the unit lenses 145a that will be described later.

In this embodiment, each light reflection part 143b is formed from white ink containing titanium oxide as a pigment. This light reflection part 143b can serve to diffuse and reflect the light. The thickness t3 of each light reflection part 143b of this embodiment is set at 10 μm. It is noted that the material of the respective light reflection parts 143b is not limited to the white ink. Namely, the light reflection parts 143b may be provided as other light reflection parts that can provide the mirror reflection (in other words, the secular reflection) to the light. For instance, such mirror light reflection parts can be formed by vapor deposition or transfer of aluminum, silver or the like. It is noted that such mirror light reflection parts can be provided to have an approximately 1 μm thickness.

As shown in FIGS. 1 and 2, an adhesive layer 146 is provided between the light selection layer 142 and the base layer 144. This adhesive layer 146 serves to join the two layers 142 and 144 to each other. Specifically, the adhesive layer 146 is provided as a transparent layer having a function to join the base layer 144 and the light reflection parts 143b together. In this embodiment, a photosensitive adhesive material having a 30 μm thickness (t6) is used as the adhesive layer 146. The adhesion properties of this adhesive layer 146 will be lost when the layer 146 is exposed to the light.

As shown in FIG. 2, this embodiment is configured, such that both of the adhesive layer 146 and joining layer 147 can remain in portions respectively facing the light transmission parts 143a. In order to achieve this configuration, it is necessary to positively suppress negative impact of the adhesive layer 146 and joining layer 147 on the optical properties of the light control sheet 14. Therefore, it is preferred that each value of the refractive indexes of the adhesive layer 146 and joining layer 147 is less than each of the refractive indexes of the support layer 141, base layer 144 and lens layer 145 that will be described later, while being near to the refractive index of the light transmission parts 143a (or near to the refractive index of air), or otherwise near to the refractive index of the base layer 144.

The base layer 144 is provided on the light incident side (or on the side of the emission tubes 13) relative to the lens layer 145. The base layer 144 can serve as a base material for the lens layer 145. In this embodiment, the base layer 144 is provided as a sheet-like member having a 100 μm thickness (t4). More specifically, the base layer 144 is provided as a polarizing optical element that can serve to transmit therethrough only the light in the certain polarized state, while reflecting the light in the other polarized state than the certain polarized state. That is to say, the base layer 144 can perform a polarization separating function that can reflect a part of the incident light, depending on the polarized state thereof, thereby separating the light in the certain state from the light in the other polarized state. In this embodiment, the base layer 144 has the polarization separating function that corresponds to the polarization separating function of the aforementioned LCD panel. Specifically, the light in the polarized state (e.g., the P-polarized state) that can be transmitted through the LCD panel 11 can also be transmitted through the base layer 144, while the light in the other polarized state (e.g., the S-polarized state) that cannot be transmitted through the LCD panel 11 will be reflected by the base layer 144.

For example, the base layer 144 is formed by alternately laminating two different polymer materials. In this case, the two polymer layers of the base layer 144 can respectively exhibit substantially the same refractive index in one of two orthogonal directions respectively parallel with the sheet surface of the base layer 144. Therefore, in this direction, there is no difference in the refractive index between the two polymer layers. However, in the other direction of the two orthogonal directions respectively parallel with the sheet surface of the base layer 144, the two polymer layers respectively exhibit different refractive indexes, thus providing a significant difference in the refractive index between the two polymer layers. With this structure, the base layer 144 can transmit therethrough the light in the polarized state having a plane of polarization parallel with the direction in which the refractive indexes of the two polymer layers are substantially the same relative to each other, while reflecting the light in the polarized state having another plane of polarization parallel with the other direction that provides the significant difference in the refractive index between the two polymer layers.

The lens layer 145 has the plurality of unit lenses 145a respectively arranged on the light outgoing side (output light side) of the base layer 144. Each unit lens 145a protrudes toward the LCD panel 11 (or light outgoing side). The unit lenses 145a are respectively arranged in one direction (i.e., the arrangement direction) on the sheet surface of the light control sheet 14. Each unit lens 145a extends linearly on the sheet surface of the light control sheet 14 in the other direction (i.e., an extending direction or a longitudinal direction) orthogonal to the arrangement direction. In this embodiment, the lens layer 145 is formed from a urethane-acrylate-type ultraviolet-curing resin. The thickness (t5) of the lens layer 145 (i.e., the length in a thickness direction from the apex of each unit lens 145a to the surface of the lens layer 145 on the side of the based layer 144) is 70 μm.

As shown in FIG. 2, each unit lens 145a has the shape corresponding to the part of the elliptic cylinder having the elliptic cross section. The major axis of the ellipse corresponding to the elliptic cross section of the elliptic cylinder extends along the normal line relative to the sheet surface of the light control sheet 14. In the cross section of this embodiment as shown in FIG. 2, each unit lens 145a is provided as the part of the elliptic shape having a 150 μm major axis and a 100 μm minor axis. The height h of each unit lens 145a (i.e., the length in the thickness direction from the apex of the unit lens 145a to the bottom of the valley portion between the unit lenses 145a) is 50 μm. Further, the pitch P of the arrangement of the unit lenses 145a is 150 μm.

As described above, the lens layer 145 of this embodiment is formed by linearly arranging the respective unit lenses 145a. Thus, when observed in the normal direction relative to the sheet surface of the light control sheet 14, the plurality of light transmission parts 143a and light reflection parts 143b are formed into a stripe pattern, respectively.

Next, one example of a method for manufacturing the light control sheet 14 of this embodiment will be described. First, the lens layer 145 is formed on the base layer 144 by an ultraviolet-ray molding method using the ultraviolet-curing resin. Then, the adhesive layer 146 is formed on the surface of the base layer 144 opposite to the lens layer 145, by coating the photosensitive adhesive material on that surface. Thereafter, a material, such as the white ink or the like, for forming the light reflection parts 143b is evenly coated, such as by printing or the like, over the surface of the coated adhesive layer 146 (opposite to the base layer 144). Thereafter, appropriate light is radiated on the side of the lens layer 145, in parallel with the normal direction relative to the sheet surface of the base layer 144. As a result, the light radiated on the side of the lens layer 145 is converged by each unit lens 145a and then transmitted through the base layer 144. Thereafter, the light reaches a region of the adhesive layer 146 overlapped with the apex of each unit lens 145a when observed in the normal direction to the sheet surface.

Once the light reaches the region of the adhesive layer 146 overlapped with the apex of each unit lens 145a when observed in the normal direction to the sheet surface and then the region is exposed to such light, the adhesive properties of the adhesive layer 146 of this region will be lost. Thus, the white ink or the like material coated on each region of the adhesive layer 146 that lost the adhesive properties can be readily removed, such as by washing or the like. Meanwhile, each region that the light cannot reach, i.e., the region of the adhesive layer 146 overlapped with each valley portion 145v between the unit lenses 145a when observed in the normal direction to the sheet surface, is not exposed to the light, thus still keeping the adhesive properties. Therefore, the white ink or the like material coated on the adhesive layer 146 in this region will further remain thereon, without being removed by washing or the like means, thereby forming each corresponding light reflection part 143b.

Next, the joining layer 147 is formed on one face of the support layer 141 that has been separately prepared. Thereafter, the layered member having the aforementioned lens layer 145, base layer 144, light reflection parts 143b respectively laminated therein is further laminated on the face of the support layer 141 having the joining layer 147 formed thereon. In this way, the layered member is joined to the support layer 141 via the joining layer 147. Thus, the light control sheet 14 can be obtained.

According to the above manufacturing method, the air exists, as the light transmission part 143a, in each portion of the light selection layer 142 where each light reflection parts 143b is not provided. By employing this manufacturing method, accurate alignment between the light transmission parts 143a and the light reflection parts 143b and the unit lenses 145a of the lens layer 145 can be readily performed.

It is noted that the aforementioned method for manufacturing the light control sheet 14 has been described, by way of example only. That is to say, the light control sheet 14 is not limited to this example, but may be manufactured by any other suitable method.

Next, the operation of the transmission-type display device, surface light source device and light control sheet, respectively constructed as described above, will be discussed.

In the above embodiment, the light emitted from each emission tube 13 used as the light source is first incident on the support layer 141 provided nearest to the emission tube 13 in the light control sheet 14. As described above, the support layer 141 has the function of isotropically diffusing the light. Therefore, the light incident on the support layer 141 is diffused isotropically. As a result, on the light outgoing side of the support layer 141, the unevenness of the brightness attributable to the arrangement or positions of light-source components (i.e., the emission tubes 13) can be well reduced.

Then, a part of the light that has been diffused and outputted from the support layer 141 travels toward each light reflection part 143b of the light selection layer 142, while the other light travels toward each light transmission part 143a. As a result, the light that travels toward each light reflection part 143b is reflected by the light reflection part 143b and returned toward the light source. Such returned light is further reflected, for example, by the reflection plate 12, then incident again on the support layer 141, and thus reused.

Meanwhile, the light that has been incident on each light transmission part 143a travels toward each corresponding unit lens 145a of the lens layer 145. Thereafter, the light is refracted at the surface (or lens surface) of each unit lens 145a, and hence the travel direction of such light is changed. After the travel direction is changed, the light outgoes from the light control sheet 14 via each unit lens 145a.

As described above, each light transmission part 143a is provided in the region including the light convergence point at which the parallel flux of light LF can be converged and the additional region around the light convergence point, when the flux of light LF traveling along the normal direction to the sheet surface of the light control sheet 14 is incident on the light control sheet 14 on the side of the lens layer 145. Further, as shown in FIG. 2, the traveling path in which the light L1 travels toward the lens surface of one unit lens 145a via the corresponding light transmission part 143a is substantially similar to the traveling path in which a light included in the parallel flux of light LF, i.e., the normal direction toward the light control sheet 14, travels, although the travel directions are reverse to each other between the two traveling path. That is to say, most of the light incident on each unit lens 145a after passing through the corresponding light transmission part 143a and then outgoing from the light control sheet 14 via the surface of the unit lens 145a is refracted such that the angle (i.e., the so-call outgoing angle) defined between the normal direction to the light control sheet 14 and the direction in which the light outgoes is substantially reduced. In this case, the light incident on each unit lens 145a after passing through the corresponding light transmission part 143a and then outgoing from the light control sheet 14 includes a relatively great amount of light outgoing in the travel direction changed to be substantially coincident with the front direction. Therefore, with such light transmission parts 143a respectively provided at appropriate positions, the front brightness can be effectively enhanced.

Meanwhile, each light reflection part 143b of the light selection layer 142 is provided in the position opposite to the corresponding valley portion 145v between each two adjacent unit lenses 145a in the normal direction to the sheet surface of the light control sheet 14. Assuming that the light could outgo from another unit lens 145a after passing through a portion corresponding to some light reflection part 143b, as depicted by a two-dot chain line in FIG. 2, such light would include a relatively great amount of light L2 that is refracted at the surface of the unit lens 145a, with the outgoing angle of the refracted light considerably enlarged. That is to say, if there is no light reflection part 143b provided in the light control sheet 14, the light outgoing in a direction out of a desired viewing-angle range would be generated in a considerably great amount. Accordingly, the provision of the respective light transmission parts 143a in appropriate positions can positively prevent the light, after transmitted through the light control sheet 14, from outgoing in the direction out of the desired viewing-angle range. As described above, according to the light control sheet 14 of this embodiment, the front brightness can be effectively enhanced, while generation of unwanted peaks of the brightness out of the desired viewing-angle range can be successfully prevented. Additionally, since the light can be reused, the unevenness of the brightness can be positively reduced, thereby enhancing the efficiency of utilizing the light.

By the way, the base layer 144, which is constructed as a polarization separating element, is provided between the lens layer 145 including the unit lenses 145a and the light selection layer 142. As described above, the base layer 144 has the optical properties that can transmit therethrough the light in the certain polarized state, while reflecting the light in the other polarized state than the certain polarized state. Accordingly, a part of the light that has been transmitted through the light transmission parts 143a of the light selection layer 142 can travel toward the lens layer 145 after transmitted through the base layer 144, while the remainder of the light is reflected by the base layer 144. Thereafter, the light reflected by the base layer 144 is further reflected, for example, by the reflection plate 12, and then incident again on the support layer 141. In this way, such reflected light can be reused.

The polarized state (e.g., the P-polarized state) that can be transmitted through the LCD panel 11 is the same as the polarized state (e.g. the P-polarized state) that can be transmitted through the base layer 144, while being different from the polarized state (e.g., the S-polarized state) that is reflected by the base layer 144. That is to say, the base layer 144 is configured to allow the light utilizable for the LCD panel 11 to be transmitted through this layer 144, while reflecting the light non-utilizable in the LCD panel 11. As discussed above, the light reflected, as the non-utilizable light, by the base layer 144 can be further or repeatedly reflected, such as by the reflection plate 12 and the like, and will be eventually changed into the light that can travel toward the observer side. In other words, the polarized state of the non-utilizable light can be changed, through such repetition of the reflection, into the polarized state (e.g., the P-polarized state) that can be transmitted through the base layer 144 and LCD panel 11. With the provision of this base layer 144, the efficiency of utilizing the light emitted from the light source can be highly enhanced. In addition, this can significantly improve the front brightness.

In this way, the light outgoing from the light control sheet 14 can be efficiently incident on the LCD panel 11, so that the image or the like displayed on the LCD panel 11 can be adequately illuminated with such light.

Now, in regard to the front brightness and the like, results of comparing the surface light source device 18 and the transmission-type display device 10, respectively related to the above embodiment using the light control sheet 14, with a comparative surface light source device and a comparative transmission-type display device, respectively using a comparative light control sheet (not shown), will be discussed.

The light control sheet related to the comparative example is different from the light control sheet 14 related to the above embodiment, in that a sheet-like member formed from a polyethylene terephthalate (PET) resin and having a 50 μm thickness is used as the base layer. However, the other parts are respectively configured in substantially the same manner as in the light control sheet 14. Namely, the light control sheet related to the comparative example does not have the function of the polarizing optical element.

Further, the surface light source device and the transmission-type display device respectively related to the comparative example are respectively different from the surface light source device 18 and the transmission-type display device 10 respectively related to the above embodiment, in that a polarization separating sheet (not shown) that can serve to enhance the brightness without narrowing the viewing-angle range is provided between the light control sheet related to the comparative example and the LCD panel 11. However, the other parts are respectively configured or provided in substantially the same manner as in the surface light source device 18 and the transmission-type display device 10. As the polarization separating sheet that is incorporated in the surface light source device and the transmission-type display device respectively related to the comparative example, a DBEF® available from SUMITOMO THREE M Co. Ltd. and having a 0.4 mm thickness is used.

As a result, the surface light source device 18 and the transmission-type display device 10, respectively related to the above embodiment using the light control sheet 14, respectively exhibit the front brightness (or brightness measured at the outgoing angle of 0° relative to the sheet surface), 30% higher than the front brightness of the surface light source device and the transmission-type display device, respectively using the light control sheet related to the comparative example. Hereinafter, the reason for this result will be discussed.

First, in the surface light source device using the light control sheet related to the comparative example, the polarization separating sheet is provided between the light control sheet related to the comparative example and the LCD panel 11. Therefore, the travel direction of the light that is once changed by each unit lens 145a to narrow the outgoing angle range is further changed by the refractive index or the like factor of the polarization separating sheet, when the light is incident on the polarization separating sheet as well as when the light outgoes from the polarization separating sheet. Therefore, in this comparative example, the light condensing effect (the light collecting effect) due to the respective unit lenses 145a is rather degraded, at the point of time that the light is incident on the LCD panel 11. Thus, in this comparative example, the front brightness cannot be enhanced as desired.

Further, in the above comparative example, the light once reflected by the polarization separating sheet may be further reflected by the light reflection parts 143b in the light control sheet and then incident again on the lens layer 145, without reaching the reflection plate 12. Thus, such light may tend to be refracted at the surface of each unit lens 145a, with the outgoing angle thereof considerably enlarged. Therefore, such light may tend to be incident on the LCD panel 11, after outgoing from the polarization separating sheet at the outgoing angle out of the desired viewing-angle range (or after outgoing from the polarization separating sheet at a considerably large outgoing angle relative to the normal direction to the sheet surface). This phenomenon cannot enhance the front brightness, as desired, as well as may generate unwanted peaks of the brightness out of the desired viewing-angle range.

Besides, in the case in which the polarization separating sheet is provided between the light control sheet related to the comparative example and the emission tubes 13 used as the light source, an adequate light condensing effect due to the unit lenses 145a can be expected. However, the polarized state of the light that is once changed into the certain polarized state by the polarization separating sheet is diffused by the support layer 141, resulting in rather disordered state. Therefore, such light in the disordered polarized state tends to be absorbed by the LCD panel 11, as the light in the other polarized state than the certain polarized state, when such light in the disordered polarized state incident on the LCD panel 11. This may lower the efficiency of utilizing the light, leading to substantial degradation of the front brightness.

Furthermore, in the case in which the polarization separating sheet is not incorporated in the surface light source device and the transmission-type display device respectively related to the comparative example, the light in the polarized state other than the certain polarized state that can be transmitted through the LCD panel 11 is absorbed by the polarizing plate of the LCD panel 11. Therefore, adequate enhancement of the front brightness cannot be expected.

Meanwhile, in the embodiment related to the present invention, the base layer 144 is provided as the polarizing optical element that can transmit therethrough only the light in the certain polarized state, while reflecting the light in the polarized state other than the certain polarized state. This base layer 144 is provided between the light selection layer 142 including the light transmission parts 143a and the light reflection parts 143b and the lens layer 145. Accordingly, in this embodiment, only the light in the certain polarized state can be transmitted through the base layer 144, after the light has been diffused by the support layer 141. Thereafter, when the light is incident on the lens layer 145 from the base layer 144, the travel direction of the light in the certain polarized state is deflected toward the front direction by the respective unit lenses 145a. Then, the light is incident on the LCD panel 11. Therefore, according to this embodiment, the unevenness of the brightness or the like negative phenomenon attributable to the arrangement or respective positions of the emission tubes 13 can be significantly reduced, thus providing more uniform in-plane distribution of the brightness. Further, only the light in a desired polarized state can be incident on the LCD panel 11, without affecting the light condensing effect (the collecting effect) of the unit lenses 145a. As such, the front brightness can be enhanced effectively.

Because the light reflected by the base layer 144 is reflected at an interface between the base layer 144 and the light transmission parts 143a, such reflected light can be securely returned toward the side of the emission tubes 13 (and/or the support layer 141 and the reflection plate 12). That is to say, unlike the light control sheet of the comparative example, the light reflected by the polarization separating sheet is not reflected by the surface of each light reflection part 143b of the light selection layer 142 on the side of the base layer 144. Accordingly, the configuration of the above embodiment can effectively prevent the light from being refracted on the surface on the light outgoing side of each unit lens 145a such that the outgoing angle is enlarged. Thus, the light control sheet 14 of this embodiment can securely enhance the front brightness, while successfully preventing the generation of unwanted peaks of the brightness out of the viewing-angle range.

According to the first embodiment as described above, the front brightness can be enhanced with high efficiency, thus providing a highly improved display of the image. Further, according to this embodiment, since the support layer 141 can serve to diffuse the light, the unevenness of the brightness can be adequately reduced. As such, the in-plane distribution of the brightness can be controlled more uniformly. Additionally, in this embodiment, there is no need of combining any other optical sheet, such as the polarization separating sheet or the like, with the light control sheet 14. In other words, this embodiment requires only the light control sheet 14 as the optical sheet. Therefore, the surface light source device and the transmission-type display device can be provided in a considerably thin and light-weight form, respectively. Furthermore, since both of the arrangement direction of the emission tubes 13 and the arrangement direction of the unit lenses 145a are respectively coincident with the vertical direction and parallel relative to each other, the unevenness of the brightness can be effectively reduced.

### Second Embodiment

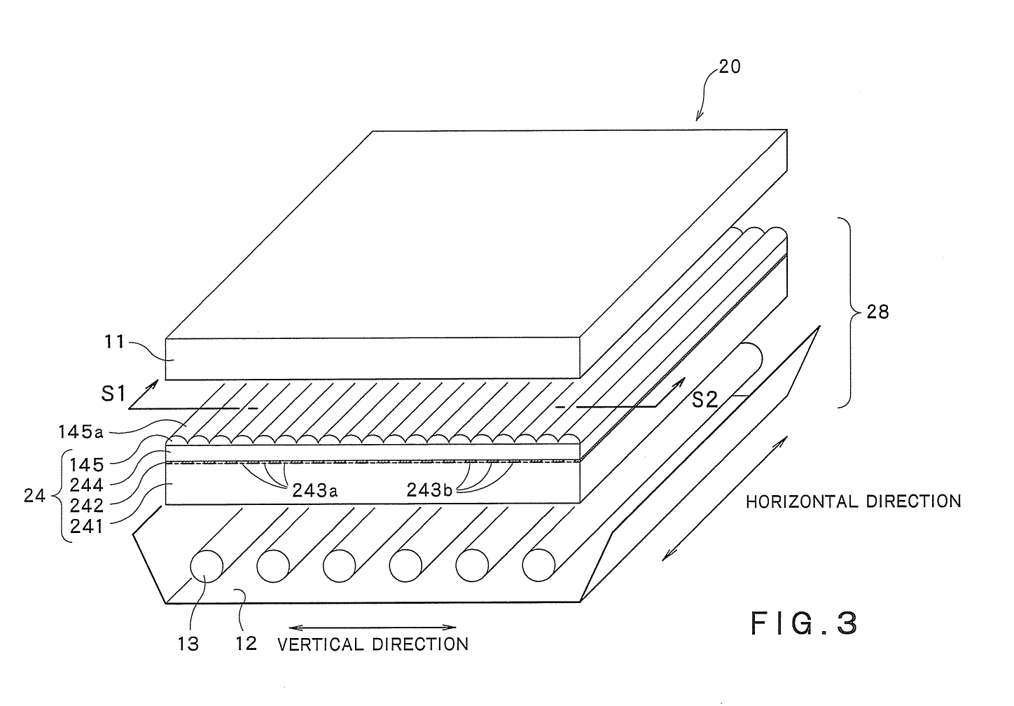

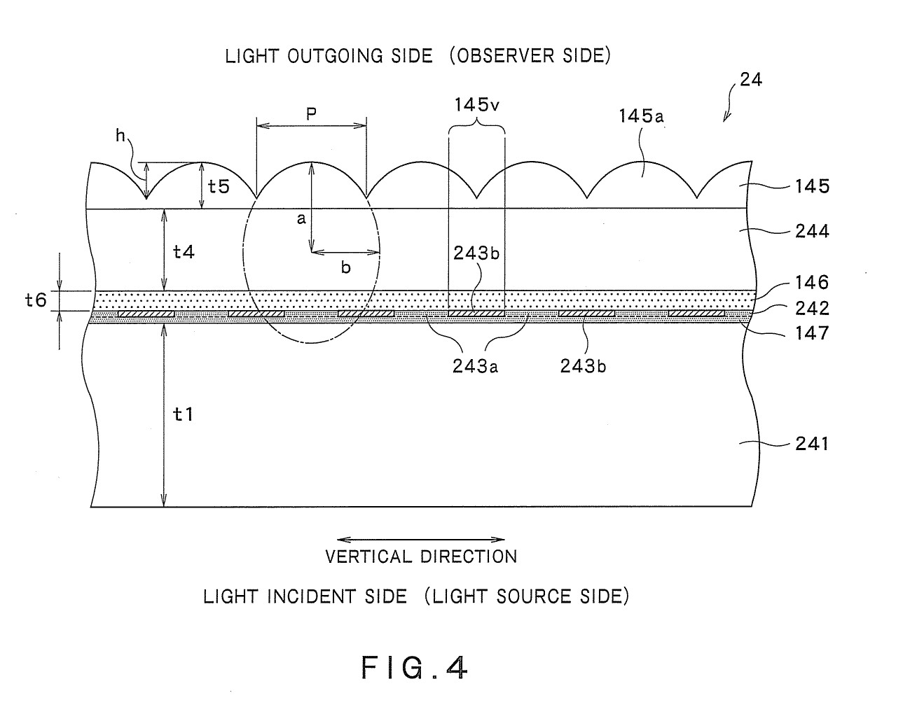

FIGS. 3 and 4 show the second embodiment, respectively. In the second embodiment, the construction of a part of the light control sheet 24 is different from the first embodiment, while the other parts are respectively provided and configured in substantially the same manner as in the light control sheet 14. Therefore, in FIGS. 3 and 4, like or same parts are respectively designated by like reference numerals used in the first embodiment, and further description on such parts will be omitted below.

In the second embodiment, the transmission-type display device 20 includes the LCD panel 11 used as the transmission-type display part, and the surface light source device 28 adapted for illuminating the LCD panel from the back side of the LCD panel. That is to say, the LCD panel 11 of this embodiment may be the same as the LCD panel used in the above first embodiment. Further, the surface light source device 28 may be provided or constructed in a similar manner to the surface light source device 18 described in the first embodiment, except that the construction of the light control sheet is substantially different between the two embodiments.

In the second embodiment, the light control sheet 24 includes the base layer 244, lens layer 145 provided on the light outgoing side (output light side) of the base layer 244 and having the plurality of unit lenses 145a, light selection layer 242 provided on the light incident side (input light side) of the base layer 244 and support layer 241 provided on the light incident side of the light selection layer 242. Additionally, the adhesive layer 146 for joining the base layer 244 and light selection layer 242 together is provided between these layers 244 and 242. Similarly, the joining layer 147 for joining the light selection layer 242 and support layer 241 together is provided between these layers 242 and 241. Among these layers, the lens layer 145, adhesive layer 146 and joining layer 147 may have the same construction as those described in the first embodiment, respectively.

The support layer 241 of the second embodiment is configured to exhibit a haze value of 30% or less. From the viewpoint of enhancing the brightness, it is preferred that the support layer 241 has the haze value of 30% or less. The reason for this condition will be described below. Specifically, in this embodiment, the support layer 241 is a sheet-like member formed from a polystyrene (PS) resin having the 1.5 mm thickness (t1). The haze value of the support layer 241 actually measured by a haze meter (produced by Murakami Sikisai Kenkyusho Co., Ltd., HR-100) was approximately 15%.

Further, as is similar to the above first embodiment, the light selection layer 242 of the second embodiment includes the plurality of light transmission parts 243a that can respectively serve to transmit the light therethrough and the plurality of light reflection parts 243b that can respectively serve to reflect the light. In addition, the positions and/or arrangement manner of the respective light transmission parts 243a and light reflection parts 243b are the same as those described in the first embodiment, respectively.

In the second embodiment, each light reflection part 243b is formed by the vapor deposition of aluminum. Thus, such light reflection parts 243b can provide the mirror reflection (the specular reflection) to the light, respectively. In this embodiment, the thickness of each light reflection part 243b is 1 μm. It is noted that the material for forming the light reflection parts 243b is not limited to aluminum, but may be selected from any other suitable metals, such as silver or the like. Further, the method for forming the light reflection parts 243b is not limited to the vapor deposition, but any other suitable method, such as the transfer process or the like, may be employed.

In order to enhance the front brightness, it is preferred that each light reflection part 243b has a reflection haze value of 20% of less. The reason for this condition will be described later. As used herein, the “reflection haze value” refers to the ratio of the component of light (or haze) that is diffusely reflected, based on the total reflection ratio of the light reflected by the respective light reflection parts 243. For instance, assuming that the total reflection ratio of the light reflected by the light, reflection parts 243 is Rt, the reflection ratio of the component of the light that is diffusely reflected is Rh, and the reflection ratio of the component of the light that is specularly reflected is Rr, the total reflection ratio Rt can be expressed by the following equation:

Rt=Rh+Rr

In this case, the reflection haze value Hr can be expressed as follows:

Hr=Rh/Rt

The reflection haze value of the light obtained by using the aforementioned haze meter (produced by Murakami Sikisai Kenkyusho Co., Ltd., HR-100), with respect to the light reflection parts 243b of the light control sheet 24 of this embodiment, was approximately 5%.

Further, in this embodiment, the light transmission parts 243a are integrally provided with the joining layer 147 and formed from the same material as the material forming the joining layer 147. That is to say, as apparently seen from FIG. 4, the material forming the joining layer 147 is contacted with the material forming the adhesive layer 146 via the respective light transmission parts 243a. In other words, the material forming the joining layer 147 is filled in each space (i.e., each light transmission part 243a) between each two adjacent light reflection parts, in place of the air filled in the space as described in the above first embodiment. In short, there is no air or the like gas filled in each light transmission part 243a of the second embodiment. In this case, it is preferred that each value of the refractive indexes of the adhesive layer 146 and joining layer 147 is less than each of the refractive indexes of the support layer 241, base layer 244 and the lens layer 145, or otherwise near to the refractive index of the base layer 244.

Unlike the base layer 144 of the first embodiment, the base layer 244 of the second embodiment is not provided as the polarization separating element. Accordingly, the base layer 244 has no polarization separating function of separating light based on the polarization thereof. This base layer 244 can serve as the base material for the lens layer 145, and is formed of a sheet-like member formed from a polyethylene terephthalate (PET) resin and having the 100 μm thickness (t4).

Next, one example of the method for manufacturing the light control sheet 14 of the second embodiment will be described. First, the lens layer 145 is formed on the base layer 244 by the ultraviolet-ray molding method using the ultraviolet-curing resin. Then, the adhesive layer 146 is formed on the surface of the base layer 244 opposite to the lens layer 145 by coating the photosensitive adhesive material on the surface. Thereafter, aluminum is deposited on the whole surface (i.e., the surface opposite to the base layer 244) of the coated adhesive layer 146. Thereafter, appropriate light parallel with the normal direction to the sheet surface of the base layer 244 is radiated on the side of the lens layer 145. Then, the light radiated on the side of the lens layer 145 is condensed (collected) by each unit lens 145a and transmitted through the base layer 244. Thereafter, the light reaches the region of the adhesive layer 146 overlapped with the apex of each unit lens 145a when observed in the normal direction to the sheet surface.

Once the light reaches the region of the adhesive layer 146 overlapped with the apex of each unit lens 145a when observed in the normal direction to the sheet surface and the region is thus exposed to the light, the adhesive properties of the adhesive layer 146 of this region will be lost. Therefore, the aluminum deposited on each region of the adhesive layer 146 that lost the adhesive properties can be readily removed, such as by washing or the like. Meanwhile, each region that the light cannot reach, i.e., the region of the adhesive layer 146 overlapped with each valley portion 145v between the unit lenses 145a when observed in the normal direction to the sheet surface, is not exposed to the light, thus keeping the aluminum adhered thereon. Therefore, the aluminum deposited on the adhesive layer 146 in this region still remains thereon, without being removed by washing or the like means, thereby forming each corresponding light reflection part 243b.

Next, the joining layer 147 is formed on one face of the support layer 241 that has been separately prepared. Thereafter, the layered member having the aforementioned lens layer 145, base layer 244, light reflection parts 243b respectively laminated therein is further laminated on the face of the support layer 241 having the joining layer 147 formed thereon. In this way, the layered member is joined to the support layer 241 via the joining layer 147. Thus, the light control sheet 24 can be obtained. By employing this manufacturing method, significantly accurate alignment between the light transmission parts 243a and light reflection parts 243b and the unit lenses 145a of the lens layer 145 can be readily performed.

It should be noted that the aforementioned method for manufacturing the light control sheet 24 has been described, by way of example only. That is to say, the light control sheet 24 is not limited to this example, but may be manufactured by any other suitable method.

Next, the operation of the transmission-type display device, surface light source device and light control sheet, respectively constructed as described above, will be discussed.

In the above embodiment, the light emitted from each emission tube 13 used as the light source is first incident on the support layer 241 provided nearest to the emission tube 13 in the light control sheet 24. As described above, the support layer 241 contains no light diffusing material kneaded therein, and the haze value of this support layer 241 is set at approximately 15%. Therefore, the light diffusing effect exerted from the support layer 241 on the light incident on this layer 241 is very small. Thus, most of the light that is incident on the support layer 241 can be transmitted through the layer 241, without being diffused so much.

Then, a part of the light that outgoes from the support layer 241 travels toward each light reflection part 243b of the light selection layer 242, while the other light travels toward each light transmission part 243a. As a result, the light that travels toward each light reflection part 243b is subjected to the mirror reflection by the light reflection part 243b and then returned toward the side of the light source. Such returned light is once transmitted through the support layer 241 and outgoes from the light control sheet 24, then reflected, for example, by the reflection plate 12 or the like, and thereafter is incident again on the support layer 241, and thus reused. In particular, in this embodiment, each light reflection part 243b has a function of specularly reflecting the light, wherein the reflection haze value of the light reflection part 243b is approximately 5%. Accordingly, such light reflection parts 243b can securely return the light coming from the support layer 241 toward the side of the emission tubes 13 with a high probability.

Meanwhile, as described in the first embodiment, most of the light that travels toward the lens layer 145 via each light transmission part 243a from the support layer 241 is refracted such that the light outgoing angle at the surface of each corresponding unit lens 145a of the lens layer 145 is reduced. Further, the light incident on each unit lens 145a via the corresponding light transmission part 243a includes a relatively great amount of light that the travel direction thereof is changed such that the outgoing direction of the light is substantially coincident with the front direction. Therefore, with such light transmission parts 243a respectively provided at appropriate positions, the front brightness can be effectively enhanced.

Assuming that the light could be incident on one unit lens 145a after passing though a point corresponding to some light reflection part 243b, such light would include a relatively great amount of light refracted at the surface of the unit lens 145a, with the outgoing angle thereof considerably enlarged. In other words, if there is no light reflection part 243b provided in the light control sheet, the light outgoing from the light control sheet 24 in the direction out of the desired viewing-angle range would be generated in a considerably great amount. Accordingly, the provision of the respective light reflecting parts 243b at appropriate positions can positively prevent the light transmitted through the light control sheet 24 from outgoing in the direction out of the desired viewing-angle range. As described above, according to the light control sheet 24 of this embodiment, the front brightness can be effectively enhanced, while the generation of unwanted peaks of the brightness out of the desired viewing-angle range can be successfully prevented. Additionally, the reuse of the light achieved by this embodiment can positively reduce the unevenness of the brightness, while significantly enhancing the efficiency of utilizing the light.

In particular, in this embodiment, the reflection haze value can be controlled to be 20% or less. Therefore, a relatively great amount of the reflected light is changed into the light component having been subjected to the mirror reflection. In addition, the haze value of the support layer 241 is 30% or less. Thus, the light diffusing effect provided to the light transmitted through the support layer 241 is very small. As such, the reflected light can be securely returned toward the side of the emission tubes 13, while the light incident again on the light control sheet 24 can be transmitted toward the observer side, more securely, through the support layer 241. As a result, the light that can be reused, among the light that is once incident on each light reflection part 243b of the light selection layer 242, can be positively increased. In this way, the efficiency of utilizing the light can be enhanced, while improving the front brightness. Furthermore, the configuration of the above embodiment can successfully achieve the turnover of the direction in which the light travel between each light reflection part 243b of the light selection layer 242 and the reflection plate 12 or the like. Thus, the unevenness of the brightness attributable to the arrangement or positions of the respective light-source components (i.e., the emission tubes 13) can be positively controlled, thereby rendering the in-plane distribution of the brightness more uniform. Thus, the image (or light image) of the light source can be controlled to be more inconspicuous.

In this way, the light outgoing from the light control sheet 24 can be adequately inputted into the LCD panel 11, and the image or the like displayed on the LCD panel 11 can be illuminated with such light.

Now, in regard to the front brightness and the like, results of comparing the surface light source device 28 and the transmission-type display device 20, respectively related to the embodiment using the light control sheet 24, with another comparative surface light source device and another comparative transmission-type display device, respectively using another comparative light control sheet (not shown), will be discussed.

The transmission-type display device related to this comparative example includes the reflection plate 12, emission tubes 13 and LCD panel 11, respectively configured in substantially the same manner as in the second embodiment. However, in place of the light control sheet 24 of the second embodiment, the transmission-type display device related to the comparative example includes an opal plate (not shown), a first light diffusing sheet (not shown), the comparative light control sheet and a second light diffusing sheet (not shown), respectively arranged in this order from the emission tubes 13. That is to say, the comparative surface light source device is composed of the reflection plate 12, emission tubes 13, opal plate (diffusing plate), first light diffusing sheet, comparative light control sheet and second light diffusing sheet.

As the comparative light control sheet, an RBEF sheet (produced by SUMITOMO THREE M Co. Ltd.) having a 160 μm thickness is used. In this sheet, a plurality of unit prisms, each having a substantially triangular-shaped cross section, are arranged along the sheet surface in the vertical direction. More specifically, in this comparative light control sheet, the plurality of unit prisms are arranged on the sheet surface of the light control sheet in one direction (i.e., the arrangement direction) parallel with the arrangement direction of the emission tubes 13. Further, each unit prism extends linearly on the sheet surface of the light control sheet in the other direction (i.e., the extending direction or the longitudinal direction) orthogonal to the one direction.

Each of the first light diffusing sheet and the second light diffusing sheet respectively used in the comparative example is formed by coating a light diffusing layer prepared by kneading micro-beads in a binder, on a transparent base material (or film) formed from the PET resin and having a 188 μm thickness. As a result, micro convex portions are formed on the light outgoing side (light output side) of the first light diffusing sheet and the second light diffusing sheet. That is to say, with such convex portions, the first light diffusing sheet and the second light diffusing sheet are provided with the light diffusing function, respectively. Specifically, a light diffusing film BS-702 produced by KEIWA Co., Ltd. is used as the first light diffusing sheet. The haze value of this first light diffusing sheet is 89.2% (in a catalogue of the maker). The total thickness of the first light diffusing layer is 220 μm. Meanwhile, another light diffusing film BS-072 produced by KEIWA Co. Ltd. is used as the second light diffusing sheet. The haze value of this second diffusing sheet is 47.9% (in the catalogue of the maker). The total thickness of the second light diffusing sheet is 210 μm.

As a result, the surface light source device 28 and the transmission-type display device 20, respectively related to the above embodiment using the light control sheet 24, respectively exhibit the front brightness (or brightness measured at the outgoing angle of 0° relative to the normal direction to the sheet surface), 10% higher than the front brightness of the surface light source device and the transmission-type display device, respectively related to the comparative example. Hereinafter, the reason for this result will be discussed.

That is to say, in the case of the surface light source device and the transmission-type display device, respectively related to the comparative example, the light emitted from the emission tubes 13 undergoes the light diffusion effect due to the light diffusion sheets and opal plate, to a greater extent, as compared with the light condensing effect (the collecting effect) provided by the unit prisms of the comparative light control sheet. Therefore, the travel direction of the light cannot be condensed (collected) well into the desired viewing-angle range. Thus, a part of the light outgoes from the surface light source in an unwanted direction out of the viewing-angle range. Therefore, in this comparative example, the front brightness tends to be degraded, leading to poor enhancement of the front brightness. In other words, such a comparative example can only exhibit the distribution of the brightness gradually changed toward the periphery from a peak of the brightness in the front direction.

Meanwhile, in the light control sheet 24 of the second embodiment, the light transmission parts 243a are provided in the positions respectively corresponding to the apexes of the unit lenses 145a (or positions respectively overlapped with the apexes of the unit lenses 145a) along the normal direction to the sheet surface of the light control sheet 24. Further, the light reflection parts 243b are arranged in the positions respectively corresponding to the valley portions 145v, each provided between each adjacent pair of the unit lenses 145a, along the normal direction to the sheet surface of the light control sheet 24. With such configuration, the outgoing angle of the light can be controlled within the desired viewing-angle range, as well as the front brightness can be enhanced with high efficiency. In addition, the reuse of the light achieved by returning the light toward the side of the emission tubes 13 can successfully mitigate the unevenness of the brightness attributable to the positions or arrangement of the respective emission tubes 13. Furthermore, this embodiment can exhibit the distribution of the brightness having a clear peak in the front direction while being kept at a considerably high level within the desired viewing-angle range. Besides, this distribution of the brightness out of the desired viewing-angle range can be sharply lowered.

Additionally, in the light control sheet 24 of the second embodiment, the haze value of the support layer 241 is 30% or less (e.g., approximately 15% in this embodiment). Therefore, the light diffusing effect that the light transmitted through the support layer 241 undergoes is very small. Thus, the light that may otherwise outgo from the light control sheet 24 in an unwanted direction, after being diffused and incident on the lens layer 145, can be well reduced. Further, in the light control sheet 24 of the second embodiment, the diffusion haze value of each light reflection part 243b is 20% or less (e.g., approximately 5% in this embodiment). Therefore, such light reflection parts 243b can mainly serve to provide the mirror reflection to the light. Accordingly, the light that would outgo from the light control sheet 24 at an unduly great angle in the case in which no light reflection part 243b is provided can be effectively returned toward the side of the emission tubes 13 and thus reused to increase the utilizable light.

According to the above second embodiment, the front brightness can be efficiently improved, as well as the unevenness of the brightness can be successfully reduced. Further, this embodiment requires only one light control sheet 24. That is to say, unlike the comparative surface light source device and the comparative transmission-type display device, there is no need for laminating the plurality of optical sheets. Accordingly, the surface light source device 28 and the transmission-type display device 20 can be provided in a considerably thin and light-weight form, respectively.

It is noted that the optical sheet disclosed in the aforementioned JP2006-208930A includes an air layer used as the opening portion provided in a position corresponding to the apex of each unit lens. That is to say, in order to condense (or collect) the light, this optical sheet utilizes a difference in the refractive indexes between the air layer and the light scattering layer, lens sheet or the like. Meanwhile, the light control sheet 24 of the above second embodiment can exhibit an adequate light condensing effect (or light collecting effect), without utilizing such an air layer as provided in the prior art optical sheet. Therefore, according to the second embodiment of this invention, the structure of the light control sheet 24 can be significantly simplified, while securely enhancing the durability against temperature and humidity. Additionally, the manufacturing process for the light control sheet 24 can be considerably simplified, thereby significantly reducing the production cost.

Besides, the light scattering layer of the optical sheet disclosed in the above JP2006-208930A has the light diffusing effect, while the light reflection layer is used to diffusely reflect the light. With such light diffusing effects, the light tends to outgo form the optical sheet in the direction out of the desired viewing-angle range, thus causing rather degradation of the front brightness. Meanwhile, in the case of the light control sheet 14 of this embodiment, the haze value of the support layer 241 is 30% or less, while the reflection haze value of each light reflection part is 20% or less. Therefore, the front brightness can be improved more effectively.

[Variation]

It is noted that various modifications can be made to the aforementioned first embodiment and the aforementioned second embodiments, respectively. Hereinafter, exemplary variations of these embodiments will be described.

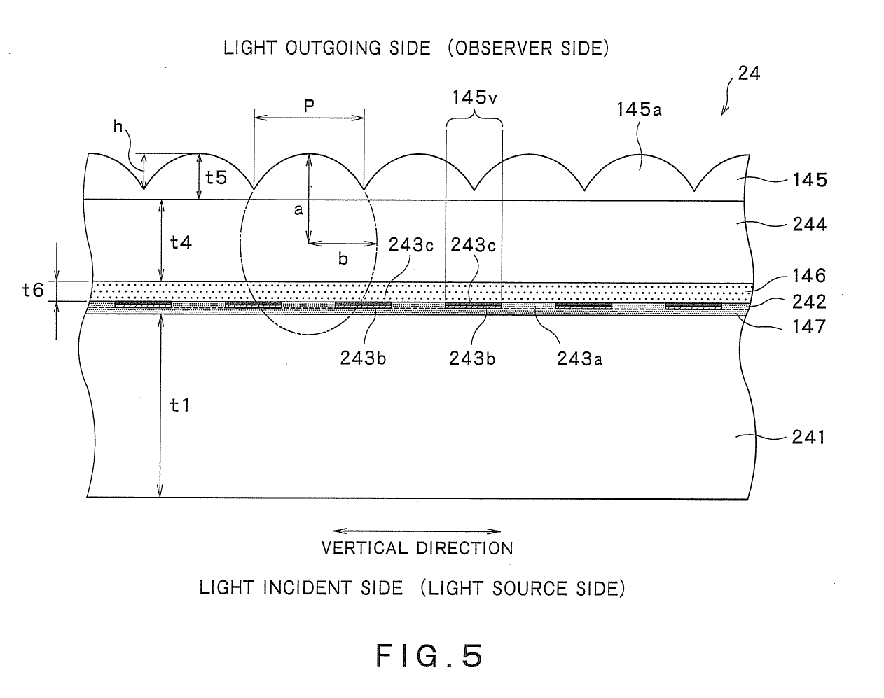

(1) For instance, as shown in FIG. 5, the light selection layers 142, 242 may have additional light absorbing parts 243c, each light absorbing part 243c being disposed on the light outgoing side of the light reflection parts 143b, 243b and having a function of absorbing the light, respectively. FIG. 5 shows one aspect in which this variation is applied to the aforementioned second embodiment. In FIG. 5, except for the addition of the light absorbing parts 243c, the other parts or portions may be respectively configured in the same manner as in the above second embodiment. Further, in FIG. 5, like parts are respectively designated by like reference numerals used in the second embodiment, and further description on such parts will be omitted below.

Each light absorbing part 243c is formed from black ink, various carbides or the like, and serves to absorb the light.

For example, the light selection layer 242 including the light absorbing parts 243c respectively laminated on the light outgoing side of the light reflection parts 243b can be formed in the following manner. First, a laminated body, which is composed of a black ink layer formed by printing or the like and a layer of aluminum or the like formed by deposition or the like, is prepared. Then, the laminated body is transferred onto the surface on the light incident side of the base layer 244 (i.e., the surface opposite to the lens layer 145). Thereafter, a laser beam is radiated on the side of the lens layer 145 in the normal direction to the sheet surface of the base layer 244, so that the black ink and aluminum can be removed by ablation. In this manner, the light reflection parts 243b as well as the light absorbing parts 243c laminated on the light outgoing side of the respective light reflection parts 243b can be formed in desired positions on the base layer 244, respectively. Otherwise, the black ink may be printed or carbon or the like material may be deposited, on the light incident side surface of the base layer 244, and then the aluminum is further deposited thereon to form the laminated body. Thereafter, the respective light reflection parts 243b and light absorbing parts 243c may be formed together by the ablation as described above.

According to such a variation, the light absorbing parts 243c are provided on the side of the lens layer 145 of the respective light reflection parts 243b. Thus, the natural light transmitted through the LCD panel 11 and/or part of image light or the like that is reflected and/or diffused by the LCD panel 11 can be absorbed by the light absorbing parts 243c. In this way, the contrast of each image or display can be enhanced. In particular, in the case in which the light control sheet 24 as shown in FIG. 5 is employed in the surface light source device and/or the transmission-type display device of the so-called area-lighting type that can illuminate each relatively bright part of an image displayed on the LCD panel 11 at a higher illuminance, while illuminating each dark part of the image at a lower illuminance, the contrast can be further enhanced.

It should be noted that while the light absorbing parts 243c have been described and shown, with reference to FIG. 5, in regard to the case in which such parts 243c are applied to the light control sheet 24 related to the second embodiment, the application of these parts 243c is not limited to this case. For instance, the light absorbing parts 243c may be provided on the light outgoing side of the respective light reflection parts 143b in the light control sheet 14 related to the first embodiment. Also in this case, the same effect as obtained by the application to the second embodiment can be expected.

(2) In the first embodiment, one example of using the light reflection parts 143b, respectively formed from the white ink or the like and thus configured to reflect the light, has been described. However, the light reflection parts 143b are not limited to this example. For instance, the light reflection parts 243b described in the second embodiment can also be applied to the light control sheet 14 related to the first embodiment. More specifically, the light reflection parts, respectively configured to provide the mirror reflection to the light, can be applied to the light control sheet 14 related to the first embodiment. Further, the light reflection parts respectively exhibiting the reflection haze value of 20% or less can also be applied to the light control sheet 14 related to the first embodiment.

(3) In the first embodiment, one example, in which each light transmission part 143a of the light selection layer 142 is formed of the void space provided between each two adjacent light reflection parts 143b of the light selection layer 142 and filled with the gas, has been discussed. However, the configuration of each light transmission part 143a is not limited to this aspect. For instance, each light transmission 143a may be formed by filling a transparent resin in the space, provided that the resin has a significantly lower refractive index, as compared with the support layer 141, base layer 144 and lens layer 145. Furthermore, the configuration of each light transmission part 243a described in the second embodiment can also be applied to the light control sheet 14 related to the first embodiment.

Additionally, the configuration of each light transmission part 143a described in the first embodiment can be applied to the light control sheet 24 related to the second embodiment.

(4) In the second embodiment, one example of using the base layer 244 having no polarization separating function has been described. However, the base layer 244 is not limited to this example. For instance, the base layer 144, which has been described in the first embodiment, as one that can serve as the polarization separating element, can also be applied to the light control sheet 24 related to the second embodiment.

(5) In the first embodiment, one example of using the support layer 141 that can positively provide the isotropic diffusion to the light transmitted through the layer 141 has been described. However, the configuration of the support layer 141 is not limited to this aspect. For instance, the support layer 141 may be formed from a substantially transparent sheet-like or film-like member exhibiting no light diffusion effect. Specifically, the support layer 241, which has been described in the second embodiment and has the haze value of 30% or less, can also be applied to the light control sheet 14 related to the first embodiment.

(6) In each of the above first and second embodiments, one example, in which each unit lens 145a of the lens layer 145 has the shape corresponding to the part of the elliptic cylinder having the elliptic cross section, with the major axis of the elliptic cross section extending in the normal direction relative to each of the light control sheets 14, 24, has been described. That is to say, in this example, the lens layer 145 includes the unit lenses 145a respectively arranged linearly. However, the configuration of the lens layer 145 and/or unit lenses 145a is not limited to this example. For instance, the configuration, in which each unit lens 145a of the lens layer 145 has the shape corresponding to the part of the spheroid having the elliptic cross section, with the major axis of the elliptic cross section extending in the normal direction relative to each of the light control sheets 14, 24, may be employed. If each unit lens is configured in this manner, the lens layer 145 is provided as the so-called fly-eye lens. With the provision of this lens layer formed of such a fly-eye lens, two-dimensional control of the light can be achieved. As such, the viewing-angle properties can be improved in two-dimensional directions.

In each of the above embodiments, the plurality of unit lenses 145a are arranged in the vertical direction as depicted in the respective drawings. However, the arrangement of these lenses 145a is not limited to this aspect. For instance, the plurality of unit lenses 145a may be arranged in the horizontal direction.

(7) In each of the first and second embodiments, one example, in which the lens layer 145 is formed by the ultraviolet-ray molding method using the ultraviolet-curing resin, has been described. However, the method of forming the lens layer 145 is not limited to this example. For instance, any other suitable photo-curing or photo-setting resin, such as an ionizing-radiation-curing resin, may be used for forming the lens layer 145. Alternatively, the lens layer 145 may be formed by extrusion molding and/or press molding using a thermoplastic resin having a suitable transparency, such as polycarbonate (PC), styrene or the like.

(8) In each of the first and second embodiments, one example, in which the emission tubes 13 are respectively arranged in one-dimensional direction, as the linear light source, has been described. However, the configuration of the light source is not limited to this example. For instance, the light source may be composed of an LED (Light Emitting Diode) formed of point light sources respectively arranged in the two-dimensional directions. Alternatively, a light emission element that can emit the light into a plane may be used as the light source.

(9) In the first embodiment, one example, in which the light reflection parts 143b are formed by printing, has been described. However, the formation of the light reflection parts is not limited to this example. For instance, the light reflection parts may be formed by any suitable transfer or deposition process. Further, in the second embodiment, one example of forming the light reflection parts 243b by deposition has been described. However, the formation of the light reflection parts 243b is not limited to this method. For instance, the light reflection parts 243b may be formed by transfer or the like method.

(10) While several variations of the first and second embodiments have been mentioned above, it should be construed that any suitable combination of such variations can also be applied to the first embodiment or the second embodiment, without departing from the scope of this invention.

1. A light control sheet, for use in a surface light source device having a light source, configured to control a travel direction of a light emitted from the light source, the light control sheet comprising:
a base layer;
a lens layer having unit lenses arranged on a light outgoing side of the base layer, each unit lens protruding toward the light outgoing side;
a light selection layer disposed on a light incident side of the base layer, the light selection layer having light transmission parts transmitting the light therethrough and light reflection parts reflecting the light; and
a support layer disposed on the light incident side of the light selection layer,
wherein the light transmission parts of the light selection layer are disposed in regions, each region including a position opposite to an apex of each corresponding unit lens in a normal direction to a sheet surface,
wherein the light reflection parts of the light selection layer are disposed in regions, each region being other than the region in which each light transmission part is disposed, alternatively to the light transmission parts, and
wherein the base layer serves as a polarizing optical element configured to transmit therethrough a light in a specified polarized state, from among the light incident on the base layer, while reflecting a light in the polarized state other than the specified polarized state.

2. The light control sheet according to claim 1,
wherein the support layer has a function of diffusing the light.

3. The light control sheet according to claim 1,
wherein a refractive index of the light transmission part is lower than a refractive index of the support layer.

4. The light control sheet according to claim 1,
wherein each light transmission part is a void space formed between two adjacent light reflection parts.

5. The light control sheet according to claim 1,
wherein each unit lens has a shape corresponding to a part of an elliptic cylinder having an elliptic cross section, or has a shape corresponding to a part of a spheroid having the elliptic cross section, with the major axis of the elliptic cross section extending in the normal direction to the sheet surface.

6. The light control sheet according to claim 1,
wherein the light reflection parts of the light selection layer are disposed out of regions including light convergence points at which flux of light is converged when the flux of light travelling in a substantially normal direction to the sheet surface is incident on the light control sheet from the side of the lens layer, as well as including regions around the light convergence points.

7. The light control sheet according to claim 1,
wherein a haze value of the support layer is 30% or less.

8. The light control sheet according to claim 1,
wherein the light reflection parts of the light selection layer are configured to specularly reflect a light.

9. The light control sheet according to claim 1,
wherein a reflection haze value of the light reflection parts is 20% or less.

10. The light control sheet according to claim 1,
wherein the light selection layer further includes light absorbing parts, and each light absorbing part is disposed on the light outgoing side of each corresponding light reflection part and having a function of absorbing a light.

11. The surface light source device comprising:
the light control sheet according to claim 1; and
the light source configured to emit the light.

12. A transmission-type display device comprising:
the surface light source device according to claim 11; and
a transmission-type display part disposed so as to be illuminated from the back side thereof by the surface light source device.

13. The transmission-type display device according to claim 12,
wherein the transmission-type display part has a polarizing plate configured to transmit therethrough the light in the specified polarized state, and
wherein the polarized state of the light that can be transmitted through the polarizing plate is the same as the polarized state of the light that can be transmitted through the base layer.

14. A light control sheet, for use in a surface light source device having a light source, configured to control a travel direction of a light emitted from the light source, the light control sheet comprising:
a base layer;
a lens layer having unit lenses arranged on a light outgoing side of the base layer, each unit lens protruding toward the light outgoing side;
a light selection layer disposed on a light incident side of the base layer, the light selection layer having light transmission parts transmitting the light therethrough and light reflection parts reflecting the light; and
a support layer disposed on the light incident side of the light selection layer,
wherein the light transmission parts of the light selection layer are disposed in regions, each region including a position opposite to an apex of each corresponding unit lens in a normal direction to a sheet surface,
wherein the light reflection parts of the light selection layer are disposed in regions, each region being other than the region in which each light transmission part is disposed, alternatively to the light transmission parts, and
wherein a haze value of the support layer is 30% or less.

15. The light control sheet according to claim 14,
wherein the light reflection parts of the light selection layer are disposed out of regions including light convergence points at which flux of light is converged when the flux of light travelling in a substantially normal direction to the sheet surface is incident on the light control sheet from the side of the lens layer, as well as including regions around the light convergence points.

16. The light control sheet according to claim 14,
wherein the light reflection parts of the light selection layer are configured to specularly reflect a light.

17. The light control sheet according to claim 14,
wherein a reflection haze value of the light reflection parts is 20% or less.

18. The light control sheet according to claim 14,
wherein the light selection layer further includes light absorbing parts, and each light absorbing part is disposed on the light outgoing side of each corresponding light reflection part and having a function of absorbing a light.

19. The light control sheet according to claim 14,
wherein each unit lens has a shape corresponding to a part of an elliptic cylinder having an elliptic cross section, or has a shape corresponding to a part of a spheroid having the elliptic cross section, with the major axis of the elliptic cross section extending in the normal direction to the sheet surface.

20. The light control sheet according to claim 14,
wherein a refractive index of the light transmission parts is lower than a refractive index of the support layer.

21. The light control sheet according to claim 14,
wherein each light transmission part is a void space formed between two adjacent light reflection parts.

22. The surface light source device comprising:
the light control sheet according to claim 14; and
the light source configured to emit the light.

23. A transmission-type display device comprising:
the surface light source device according to claim 22; and
a transmission-type display part disposed so as to be illuminated from the back side thereof by the surface light source device.
